(19) United States
(12) Patent Application Publication
(10) Pub. No.: US 2024/0270955 A1
(43) Pub. Date: Aug. 15, 2024

(54) FLAME-RETARDANT RESIN COMPOSITION, INSULATED ELECTRIC WIRE, AND WIRE HARNESS

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Tatsuya HASE, Mie (JP); Tatsuya SHIMADA, Mie (JP)

(21) Appl. No.: 18/023,847

(22) PCT Filed: Aug. 2, 2021
(86) PCT No.: PCT/JP2021/028628

§ 371 Date: Oct. 20, 2023

(30) Foreign Application Priority Data
Sep. 3, 2020 (JP) 2020-148059

(51) Int. Cl. C08L 51/06; C08K 3/22; H01B 3/44

(52) U.S. Cl. CPC C08L 51/06; C08K 3/22; H01B 3/441; C08K 2003/2224; C08K 2003/2227; C08K 2201/005; C08L 2201/02; C08L 2205/025; C08L 2205/035; C08L 2207/062

(57) ABSTRACT

Provided is a silane-crosslinkable polyolefin-based flame-retardant resin composition having high flexibility and high handleability, and an insulated electric wire and a wire harness obtained using the flame-retardant resin composition. The flame-retardant resin composition includes, as resin components: a silane-grafted polyolefin (A) obtained by grafting a silane coupling agent onto a polyolefin; an unmodified polyolefin (B); and a modified polyolefin (C) having one or more functional groups selected from a carboxyl group, an ester group, an acid anhydride group, an amino group, and an epoxy group. The resin composition further includes a flame retardant (D) and a crosslinking catalyst (E). A crosslinked product obtained by subjecting the flame-retardant resin composition to silane crosslinking has a melting point of 80° C. or higher and a flexural modulus of 100 MPa or less.

### TECHNICAL FIELD

The present disclosure relates to a flame-retardant resin composition, an insulated electric wire, and a wire harness.

### BACKGROUND

Insulated electric wires that are used in automobiles are sometimes used at positions where the temperature becomes high, such as the vicinity of the engine, and are required to have high heat resistance. Conventionally, a crosslinked polyvinyl chloride resin or a crosslinked polyolefin resin has been used as a coating material of such an insulated electric wire. Electron beam crosslinking has mainly been used as the method for manufacturing these crosslinked resins (see, for example, Patent Document 1).

However, there has been a problem in that electron beam crosslinking requires an expensive electron beam crosslinking apparatus and the like, and equipment cost is high, and thus manufacturing cost increases. In view of this, silane crosslinking, with which crosslinking is possible with inexpensive equipment, has been receiving attention. A silane-crosslinkable polyolefin resin composition is known which is used in a coating material for an electric wire, a cable, and the like (see, for example, Patent Document 2).

### PRIOR ART DOCUMENT

### Patent Documents

Patent Document 1: JP 2000-294039A

Patent Document 2: JP 2000-212291A

### SUMMARY OF INVENTION

### Problem to be Solved

In a case where a silane-crosslinkable polyolefin is used in a product that is used in an environment where it is often subjected to high temperatures, such as an electric wire for automobiles, it is necessary to impart flame retardancy. It is possible to impart flame retardancy by adding a flame retardant to a silane-crosslinkable resin. If a flame retardant, or in particular, an inorganic flame retardant such as a metal hydroxide is added in a large amount, the mechanical properties of the resin component may be impaired. In particular, a reduction in flexibility is likely to be an issue.

In order to suppress the influence of the reduction in flexibility due to addition of the flame retardant, it is conceivable to use a resin having high flexibility as a base resin that constitutes the silane-crosslinkable polyolefin. Examples of polyolefin resins having high flexibility include low-density resins that include many amorphous portions and in which the amount of copolymers is increased using a metallocene-based polymerization catalyst. However, in most cases, such polyolefin resins having high flexibility have low melting points. If such a polyolefin resin having a low melting point is used as a base resin of a silane-crosslinkable resin composition, the resin composition is likely to cause blocking (adhesion due to close contact) of materials. For example, if blocking occurs in a state where the resin composition has been extruded onto the outer circumference of a conductor to manufacture an insulated electric wire, handleability of the insulated electric wire before crosslinking is impaired. In particular, if blocking occurs at room temperature, handleability of the insulated electric wire during its manufacture is significantly impaired. Moreover, a crosslinked product of the resin composition containing the polyolefin resin having a low melting point has a sticky surface, and this may impair handleability of a product such as an insulated electric wire after crosslinking.

Under the above circumstances, an object of the present disclosure is to provide a silane-crosslinkable polyolefin-based flame-retardant resin composition that has high flexibility and high handleability, and an insulated electric wire and a wire harness obtained using the flame-retardant resin composition.

### Means to Solve the Problem

A first flame-retardant resin composition according to the present disclosure includes, as resin components: a silane-grafted polyolefin (A) obtained by grafting a silane coupling agent onto at least one polyolefin; an unmodified polyolefin (B); and a modified polyolefin (C) having one or more functional groups selected from a carboxyl group, an ester group, an acid anhydride group, an amino group, and an epoxy group, the flame-retardant resin composition further including: a flame retardant (D); and a crosslinking catalyst (E), wherein a crosslinked product obtained by subjecting the flame-retardant resin composition to silane crosslinking has a melting point of 80° C. or higher and a flexural modulus of 100 MPa or less.

A second flame-retardant resin composition according to the present disclosure includes, as resin components: a silane-grafted polyolefin (A) obtained by grafting a silane coupling agent onto at least one polyolefin; an unmodified polyolefin (B); and a modified polyolefin (C) having one or more functional groups selected from a carboxyl group, an ester group, an acid anhydride group, an amino group, and an epoxy group, the flame-retardant resin composition further including: a flame retardant (D); and a crosslinking catalyst (E), wherein the at least one polyolefin constituting the silane-grafted polyolefin (A) includes: a first polyolefin (a-1) having a density of 0.870 g/cm³ or less, a melting point of 110° C. or higher, and a flexural modulus of 11 MPa or less; and a second polyolefin (a-2) having a density of 0.870 g/cm³ or less, a melting point of 60° C. or lower, and a flexural modulus of 11 MPa or less, and the first polyolefin (a-1) and the second polyolefin (a-2) are mixed at a mass ratio (a-1)/(a-2) within a range of 30/70 or more and 70/30 or less.

An insulated electric wire according to the present disclosure includes a conductor and an electric wire coating material constituted by a crosslinked product of the first or second flame-retardant resin composition and covering an outer circumference of the conductor. A wire harness according to the present disclosure includes the insulated electric wire.

### Effects of the Invention

A flame-retardant resin composition according to the present disclosure is a silane-crosslinkable polyolefin-based flame-retardant resin composition that has high flexibility and high handleability. An insulated electric wire and a wire harness according to the present disclosure are obtained using the flame-retardant resin composition.

### BRIEF DESCRIPTION OF THE DRAWINGS

FIG. 1 is a perspective view showing an insulated electric wire according to an embodiment of the present disclosure.

FIG. 2 is a DSC curve of silane-grafted PE1.

### DETAILED DESCRIPTION TO EXECUTE THE INVENTION

### Description of Embodiments of Present Disclosure

First, embodiments of the present disclosure will be described.

A first flame-retardant resin composition according to the present disclosure includes, as resin components: a silane-grafted polyolefin (A) obtained by grafting a silane coupling agent onto at least one polyolefin; an unmodified polyolefin (B); and a modified polyolefin (C) having one or more functional groups selected from a carboxyl group, an ester group, an acid anhydride group, an amino group, and an epoxy group, the flame-retardant resin composition further including: a flame retardant (D); and a crosslinking catalyst (E), wherein a crosslinked product obtained by subjecting the flame-retardant resin composition to silane crosslinking has a melting point of 80° C. or higher and a flexural modulus of 100 MPa or less.

In general, if a crosslinked product of a silane-crosslinkable resin composition has a high melting point and a low flexural modulus, this indicates that the resin composition also has a high melting point and a low flexural modulus before crosslinking. The first flame-retardant resin composition described above has a low flexural modulus and forms the crosslinked product having a flexural modulus of 100 MPa or less. Accordingly, the resin composition and the crosslinked product have high flexibility. At the same time, the flame-retardant resin composition has a high melting point and forms the crosslinked product having a melting point of 80° C. or higher. Accordingly, blocking is unlikely to occur at temperatures around room temperature. Therefore, it is possible to avoid a situation in which blocking impairs handleability of a product formed using the flame-retardant resin composition, such as an insulated electric wire before crosslinking. Moreover, the crosslinked resin is unlikely to be sticky at temperatures around room temperature, and therefore, it is possible to avoid a situation in which stickiness impairs handleability of a product including the crosslinked product of the flame-retardant resin composition, such as an insulated electric wire after crosslinking. As described above, the flame-retardant resin composition and the crosslinked product thereof have high flexibility and high handleability at the same time.

Here, it is preferable that the at least one polyolefin constituting the silane-grafted polyolefin (A) includes a first polyolefin (a-1) and a second polyolefin (a-2), and the first polyolefin (a-1) has a higher melting point than the second polyolefin (a-2). If the silane-grafted polyolefin (A) is constituted by a mixture of two base polyolefins having different melting points, it is possible to control the melting point and flexibility in a more varied manner when compared with a case where only one base polyolefin is used. Accordingly, it becomes easier to obtain a flame-retardant resin composition and a crosslinked product having a low flexural modulus and a high melting point at the same time.

In this case, it is preferable that the first polyolefin (a-1) has a density of 0.870 g/cm³ or less, a melting point of 110° C. or higher, and a flexural modulus of 11 MPa or less, the second polyolefin (a-2) has a density of 0.870 g/cm³ or less, a melting point of 60° C. or lower, and a flexural modulus of 11 MPa or less, and the first polyolefin (a-1) and the second polyolefin (a-2) are mixed at a mass ratio (a-1)/(a-2) within a range of 30/70 or more and 70/30 or less. Both the first polyolefin (a-1) and the second polyolefin (a-2) have a low density of 0.870 g/cm³ or less and a low flexural modulus of 11 MPa or less. The second polyolefin (a-2) has a low melting point of 60° C. or lower, whereas the first polyolefin (a-1) has a high melting point of 110° C. or higher. When these two types of polyolefins are mixed and used as base resins of the silane-grafted polyolefin (A), a crosslinked product obtained by subjecting the flame-retardant resin composition to silane crosslinking tends to have a flexural modulus of 100 MPa or less and a melting point of 80° C. or higher. Therefore, it becomes easier to obtain a flame-retardant resin composition and a crosslinked product having high flexibility and high handleability.

A second flame-retardant resin composition according to the present disclosure includes, as resin components: a silane-grafted polyolefin (A) obtained by grafting a silane coupling agent onto at least one polyolefin; an unmodified polyolefin (B); and a modified polyolefin (C) having one or more functional groups selected from a carboxyl group, an ester group, an acid anhydride group, an amino group, and an epoxy group, the flame-retardant resin composition further including: a flame retardant (D); and a crosslinking catalyst (E), wherein the at least one polyolefin constituting the silane-grafted polyolefin (A) includes: a first polyolefin (a-1) having a density of 0.870 g/cm³ or less, a melting point of 110° C. or higher, and a flexural modulus of 11 MPa or less; and a second polyolefin (a-2) having a density of 0.870 g/cm³ or less, a melting point of 60° C. or lower, and a flexural modulus of 11 MPa or less, and the first polyolefin (a-1) and the second polyolefin (a-2) are mixed at a mass ratio (a-1)/(a-2) within a range of 30/70 or more and 70/30 or less.

In the second flame-retardant resin composition described above, the first polyolefin (a-1) and the second polyolefin (a-2) each having a predetermined density, a predetermined flexural modulus, and a predetermined melting point are used as base polyolefins constituting the silane-grafted polyolefin (A). Since the two types of base polyolefins both have a low density and a low flexural modulus, the flame-retardant resin composition as a whole and a crosslinked product thereof have a low flexural modulus and high flexibility. Moreover, the first polyolefin (a-1) having a high melting point of 110° C. or higher is used in addition to the second polyolefin (a-2) having a low melting point of 60° C. or lower, and therefore, the crosslinked product of the flame-retardant resin composition can have a high melting point of 80° C. or higher without its high flexibility being impaired. The flame-retardant resin composition forms such a crosslinked product having a high melting point, and accordingly, blocking of the flame-retardant resin composition is unlikely to occur at temperatures around room temperature, and handleability of the flame-retardant resin composition is excellent. Also, the crosslinked resin is unlikely to be sticky at temperatures around room temperature, and a product including the crosslinked product of the flame-retardant resin composition also has high handleability. As described above, the flame-retardant resin composition and the crosslinked product thereof have high flexibility and high handleability at the same time.

It is preferable that the unmodified polyolefin (B) included in the first or second flame-retardant resin composition has a density of 0.950 g/cm³ or less and a flexural modulus of 200 MPa or less. In this case, the flame-retardant resin composition tends to have improved flexibility.

It is preferable that the flame-retardant resin composition includes, as the resin components: 10 parts by mass or more and 70 parts by mass or less of the silane-grafted polyolefin (A); 20 parts by mass or more and 60 parts by mass or less of the unmodified polyolefin (B); and 1 part by mass or more and 30 parts by mass or less of the modified polyolefin (C). In this case, the flame-retardant resin composition tends to have high flexibility and high handleability due to having a high melting point, in a well-balanced manner.

It is preferable that at least one of magnesium hydroxide and aluminum hydroxide is contained as the flame retardant (D) in a total amount of 30 parts by mass or more and 150 parts by mass or less with respect to 100 parts by mass of the resin components. In order to make the resin composition exhibit sufficiently high flame retardancy, magnesium hydroxide and aluminum hydroxide need to be added to the resin composition in a large amount when compared with bromine-based flame retardants and the like, and the physical properties of the resin components such as flexibility tend to be impaired by addition of a large amount of magnesium hydroxide or aluminum hydroxide. However, the resin components of the flame-retardant resin composition have high flexibility, and therefore, even when such a flame retardant is added, the resin composition as a whole can maintain high flexibility. In particular, when the flame retardant is added in an amount that falls within the above-described range, excellent flame retardancy and excellent flexibility tend to be obtained at the same time.

It is preferable that the magnesium hydroxide and the aluminum hydroxide have an average particle size of 0.5 μm or more and 5.0 μm or less. In this case, these flame retardants tend to be sufficiently dispersed without aggregating in the resin components, and the flame-retardant resin composition as a whole tends to maintain high flexibility.

It is preferable that the crosslinking catalyst (E) is contained in an amount of 0.1 parts by mass or more and 1 part by mass or less with respect to 100 parts by mass of the resin components. In this case, crosslinking of the resin composition is sufficiently promoted, and a crosslinked product having a high melting point and a low flexural modulus tends to be formed.

It is preferable that the flame-retardant resin composition contains at least one of: a hindered phenol-based antioxidant (F); a metal oxide (G); a sulfur-based antioxidant (H); and a lubricant (I). If the flame-retardant resin composition contains the components (F) to (I), properties of the flame-retardant resin composition as a whole can be improved by functions of the respective components.

In this case, it is preferable that the sulfur-based antioxidant (H) includes at least one imidazole-based compound. In this case, it is possible to impart an excellent antioxidation effect and excellent heat resistance to the flame-retardant resin composition.

The components (F) to (I) are preferably contained in the following amounts with respect to 100 parts by mass of the resin components: 0.5 parts by mass or more and 20 parts by mass or less of the hindered phenol-based antioxidant (F); 0.5 parts by mass or more and 15 parts by mass or less of the metal oxide (G); 0.5 parts by mass or more and 20 parts by mass or less of the sulfur-based antioxidant (H); and 0.1 parts by mass or more and 5 parts by mass or less of the lubricant (I). If the contents of the components (F) to (I) in the flame-retardant resin composition fall within the respective ranges described above, it is possible to sufficiently obtain effects of the addition of the components without impairing properties of the flame retardant resin composition such as flexibility and high handleability, which are exhibited due to the resin components.

An insulated electric wire according to the present disclosure includes a conductor and an electric wire coating material constituted by a crosslinked product of either one of the above-described flame-retardant resin compositions and covering an outer circumference of the conductor. A wire harness according to the present disclosure includes the insulated electric wire. Since the electric wire coating material of the insulated electric wire and the wire harness is formed using either one of the above-described flame-retardant resin compositions, high flexibility is exhibited before and after crosslinking, and high handleability is obtained due to suppression of blocking and stickiness.

### Details of Embodiments of Present Disclosure

The following describes a flame-retardant resin composition, an insulated electric wire, and a wire harness according to embodiments of the present disclosure in detail. The flame-retardant resin composition according to an embodiment of the present disclosure is a silane-crosslinkable polyolefin-based resin composition that contains components described below. The insulated electric wire according to an embodiment of the present disclosure is obtained using the flame-retardant resin composition according to an embodiment of the present disclosure, and the wire harness according to an embodiment of the present disclosure includes the insulated electric wire according to an embodiment of the present disclosure.

### Flame-Retardant Resin Composition

First, the flame-retardant resin composition (hereinafter may be simply referred to as a “resin composition”) according to an embodiment of the present disclosure will be described.

The flame-retardant resin composition according to an embodiment of the present disclosure (hereinafter also referred to as “the resin composition”) contains, as resin components, a silane-grafted polyolefin (A), an unmodified polyolefin (B), and a modified polyolefin (C). The resin composition further contains a flame retardant (D) and a crosslinking catalyst (E). In addition, the resin composition preferably contains at least one of: a hindered phenol-based antioxidant (F); a metal oxide (G); a sulfur-based antioxidant (H); and a lubricant (I), and more preferably contains all of these. Moreover, a crosslinked product obtained by subjecting the resin composition to silane crosslinking has a melting point of 80° C. or higher and a flexural modulus of 100 MPa or less.

The following describes details of each component contained in the resin composition and properties of the resin composition. In the following description, the content of each component is expressed taking the total mass of resin components to be 100 parts by mass. Here, the term “resin components” refers to the components (A) to (C) described above. In a case where the resin composition further contains other resin materials, the “resin components” also include the other resin materials. In a case where the resin composition contains a plurality of chemical species that are classified into the same group, the content of the group indicates the total content of the plurality of chemical species unless otherwise specified. Each physical property value is a value measured in the atmosphere at room temperature unless otherwise specified.

### [1] Components Contained in the Resin Composition

### Silane-Grafted Polyolefin (A)

The silane-grafted polyolefin (A) is obtained by introducing a silane-grafted chain into a polyolefin serving as a main chain by grafting a silane coupling agent onto the polyolefin.

There is no particular limitation on the polyolefin (base polyolefin) used for the silane-grafted polyolefin (A), and preferable examples thereof include homopolymers of ethylene and propylene, copolymers of ethylene and a-olefins, and copolymers of propylene and a-olefins. Also, a polyolefin elastomer obtained by using olefin as the base may be used as the above-described polyolefin.

Low-density polyethylene (LDPE), linear low-density polyethylene (LLDPE), very-low-density polyethylene (VLDPE), or metallocene low-density polyethylene is preferably used as the polyethylene. Any one of these polyethylenes may be used alone or two or more of them may be used in combination. If these low-density polyethylenes are used, the resin composition and a crosslinked product thereof have particularly high flexibility.

Examples of the polyolefin elastomer include polyolefin-based thermoplastic elastomers (TPO) such as polyethylene-based elastomers (PE elastomers) and polypropylene-based elastomers (PP elastomers), ethylene-propylene rubbers (EPM, EPR), and ethylene-propylene-diene copolymers (EPDM, EPT). Any one of these polyolefin elastomers may be used alone or two or more of them may be used in combination. If polyolefin elastomers are used, it is possible to impart high flexibility to the resin composition and a crosslinked product thereof.

As the base polyolefin of the silane-grafted polyolefin (A), it is possible to use a single type of polyolefin alone or two or more types of polyolefins in combination from among those listed above, for example, but it is preferable to use a mixture of two or more types of polyolefins as base polyolefins, such as a first polyolefin (a-1) and a second polyolefin (a-2), which will be described later. Out of the above-listed examples of the base polyolefin of the silane-grafted polyolefin (A), it is preferable to use at least one selected from polyethylene, polypropylene, an ethylene-butene copolymer, an ethylene-octene copolymer, and a polyolefin elastomer. In particular, a polyolefin elastomer is preferably used from the viewpoint of obtaining high flexibility of the resin composition.

As described later, it is preferable to use a mixture of a plurality of polyolefins such as the first polyolefin (a-1) and the second polyolefin (a-2) that differ from each other in at least the melting point, as the base polyolefins of the silane-grafted polyolefin (A). In this case, the plurality of base polyolefins may be of different types, or of the same type and have different properties due to a difference in the specific structure of molecular chains, such as the degree of polymerization of the main chain, the presence or absence of branched chains, the number or the length of branched chains, or the like. Commonly, the larger the number of branches included in the polymer chain of a polyolefin is and the longer branched side chains are, the lower the density is and the higher the flexibility is, but the lower the melting point tends to be.

The silane coupling agent used in the silane-grafted polyolefin (A) is not particularly limited, and examples thereof include vinyl alkoxysilanes such as vinyltrimethoxysilane, vinyltriethoxysilane, and vinyltributoxysilane, vinyltriacetoxysilane, γ-methacryloxypropyltrimethoxysilane, and γ-methacryloxypropylmethyldimethoxysilane. Any one of these silane coupling agents may be used alone or two or more of them may be used in combination.

From the viewpoint of preventing excessive crosslinking, an upper limit of the graft amount of the silane coupling agent is preferably 15 mass % or less, more preferably 10 mass % or less, and even more preferably 5 mass % or less. On the other hand, a lower limit of the graft amount is preferably 0.1 mass % or more, more preferably 1.0 mass % or more, and even more preferably 1.5 mass % or more. When the resin composition is crosslinked to form an electric wire coating material, for example, the resin composition is sufficiently crosslinked and excellent heat resistance and excellent mechanical strength can be obtained if the graft amount is 0.1% or more. Note that the graft amount expresses the mass of the grafted silane coupling agent as a percentage with respect to the mass of the polyolefin before silane grafting.

The base polyolefin of the silane-grafted polyolefin (A) preferably has a density of 0.870 g/cm³ or less before grafting (the same applies to the following description of densities of base polyolefins of the silane-grafted polyolefin). The lower the density of the polyolefin is, the easier it is to graft the silane coupling agent, the easier it is to increase a crosslink density, and the higher the flexibility becomes. The density of the base polyolefin is more preferably 0.866 g/cm³ or less. A lower limit is not particularly set for the density of the base polyolefin of the silane-grafted polyolefin (A), but the density is preferably 0.855 g/cm³ or more, and more preferably 0.857 g/cm³ or more from the viewpoint of obtaining a resin composition having a high melting point and excellent wear resistance, for example. In the case where two or more polyolefins are used as the base polyolefins of the silane-grafted polyolefin (A), it is preferable that each polyolefin has the density described above, and it is more preferable that a mixture of the two or more polyolefins also has the density described above. The density of a resin material can be measured in accordance with ASTM D790.

The silane-grafted polyolefin (A) preferably has a flexural modulus of 11 MPa or less (after silane grafting). If the silane-grafted polyolefin (A) has a low flexural modulus, the silane-grafted polyolefin (A) and the resin composition containing the silane-grafted polyolefin (A) tend to have high flexibility. The flexural modulus is more preferably 10 Mpa or less, and even more preferably 8 Mpa or less. A lower limit is not particularly set for the flexural modulus of the silane-grafted polyolefin (A), but a silane-grafted polyolefin having a low flexural modulus tends to have a low melting point, and accordingly, the flexural modulus is preferably 3 Mpa or more, and even more preferably 5 Mpa or more from the viewpoint of obtaining a resin composition having a high melting point and high wear resistance, for example. In the case where two or more polyolefins are used as the base polyolefins of the silane-grafted polyolefin (A), it is preferable that a grafted product of each polyolefin has the flexural modulus described above, and it is more preferable that a grafted product of the mixture of the two or more polyolefins also has the flexural modulus described above. The flexural modulus of a resin material can be measured in accordance with ASTM D790.

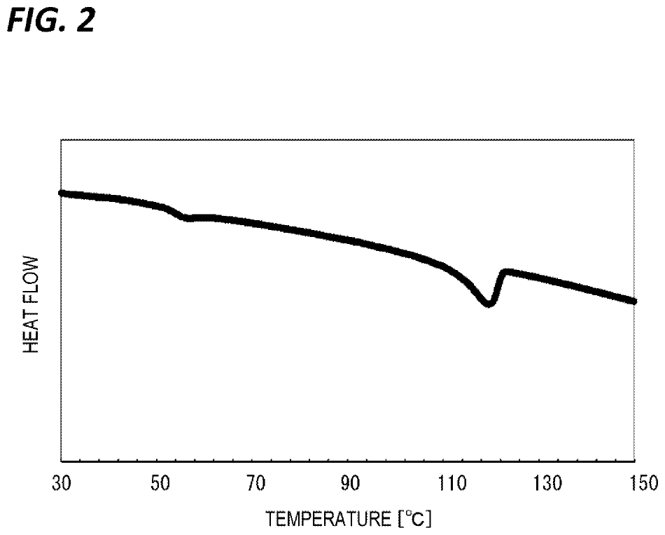

The silane-grafted polyolefin (A) preferably has a melting point of 80° C. or higher (after silane grafting). The melting point is more preferably 100° C. or higher, even more preferably 110° C. or higher, and further preferably 120° C. or higher. If a silane-grafted polyolefin having such a high melting point is used, the resin composition or a crosslinked product thereof as a whole tends to have a high melting point, and blocking of the resin composition tends to be suppressed. Moreover, stickiness of the crosslinked product tends to be suppressed. An upper limit of the melting point is not particularly specified, but a silane-grafted polyolefin that is excellent in flexibility and other physical properties generally has a melting point of 135° C. or lower. Note that the melting point of a resin material can be measured using differential scanning calorimetry (DSC) in accordance with JIS K7121. In the case where two or more polyolefins are used as the base polyolefins of the silane-grafted polyolefin, the above-described melting point is a value measured after the mixture of the two polyolefins is subjected to silane grafting. When the melting point of a silane-grafted polyolefin obtained by subjecting a mixture of two or more polyolefins to silane grafting is measured using DSC, a single heat absorption peak is usually observed (see FIG. 2), and accordingly, the temperature at the peak top can be taken as the melting point, but if a plurality of heat absorption peaks are observed, the temperature of a peak top that is the lowest among temperatures of the plurality of peaks can be taken as the melting point.

Properties of the silane-grafted polyolefin (A) contained in the resin composition have a great influence on properties of the resin composition as a whole, but there is no particular limitation on specific configurations of the base polyolefin of the silane-grafted polyolefin (A) as long as the crosslinked product of the resin composition as a whole has a flexural modulus of 100 Mpa or less and a melting point of 80° C. or higher. The silane-grafted polyolefin (A) may be constituted by only one base polyolefin or a mixture of two or more base polyolefins as described above. However, in general, a polyolefin having a low density is flexible and contributes to obtaining a low flexural modulus, but tends to have a low melting point. Accordingly, in order to obtain a low flexural modulus and a high melting point at the same time with use of only one type of polyolefin, the type of polyolefin that can be selected is limited. However, if two or more types of polyolefins having different properties are mixed, the freedom increases in setting physical properties such as the flexural modulus and the melting point of the mixture as a whole after silane grafting. Therefore, it becomes easy to obtain a resin composition and a crosslinked product having both a low flexural modulus and a high melting point.

Specifically, it is preferable that the silane-grafted polyolefin (A) is constituted by base polyolefins including the first polyolefin (a-1) and the second polyolefin (a-2), and the first polyolefin (a-1) has a higher melting point than the second polyolefin (a-2). In this case, the base polyolefins as a whole tend to have a low flexural modulus mainly due to contribution of the second polyolefin (a-2) and a high melting point due to contribution of the first polyolefin (a-1). There is no particular limitation on specific melting points of the first polyolefin (a-1) and the second polyolefin (a-2), but when an envisaged melting point of the base polyolefins of the silane-grafted polyolefin (A) as a whole or an envisaged melting point of the resin composition and the crosslinked product as a whole is taken as a reference melting point, the melting point of the first polyolefin (a-1) is preferably higher than the reference melting point and the melting point of the second polyolefin (a-2) is preferably lower than the reference melting point. Also, there is no particular limitation on a difference between the melting point of the first polyolefin (a-1) and the melting point of the second polyolefin (a-2), but the difference is preferably 50° C. or more, and more preferably 60° C. or more from the viewpoint of obtaining a low flexural modulus and a high melting point at the same time. An upper limit is not particularly set for the difference between the melting points, but the difference is preferably about 100° C. or less.

The following is an example of a preferable combination of two base polyolefins that makes it possible to obtain a crosslinked product having a flexural modulus of 100 Mpa or less and a melting point of 80° C. or higher from the resin composition containing the silane-grafted polyolefin (A) according to an embodiment of the present disclosure.

First polyolefin (a-1): melting point of 110° C. or higher

Second polyolefin (a-2): melting point of 60° C. or lower

It is preferable that both the first polyolefin (a-1) and the second polyolefin (a-2) have a density of 0.870 g/cm³ or less, or more preferably 0.866 g/cm³ or less as described above. The lower limit is not particularly limited, but is preferably 0.855 g/cm³ or more, and more preferably 0.857 g/cm³ or more. Furthermore, it is preferable that both the first polyolefin (a-1) and the second polyolefin (a-2) have a flexural modulus of 11 Mpa or less, more preferably 10 Mpa or less, or even more preferably 8 Mpa or less as described above. The lower limit is not particularly limited, but is preferably 3 Mpa or more, and more preferably 5 Mpa or more.

If both the first polyolefin (a-1) and the second polyolefin (a-2) have a low density of 0.870 g/cm³ or less and a low flexural modulus of 11 Mpa or less, the base polyolefins as a whole tend to have a low flexural modulus. Although a polyolefin having a low density and a low flexural modulus tends to have a low melting point, the use of the second polyolefin (a-2) having a melting point of 110° C. or higher makes it easy to achieve a melting point of 80° C. or higher for the base polyolefins of the component (A) as a whole and consequently the resin composition and the crosslinked product as a whole.

From the viewpoint of sufficiently obtaining contributions of the two polyolefins, a mixing ratio (a-1)/(a-2) between the first polyolefin (a-1) and the second polyolefin (a-2) on the mass basis is preferably 30/70 or more, and more preferably 40/60 or more. Also, the mixing ratio is preferably 70/30 or less, and more preferably 60/40 or less. From the viewpoint of obtaining a low flexural modulus and a high melting point at the same time and simplifying the composition of the component, it is preferable to use, as the base polyolefins of the silane-grafted polyolefin (A), two types of polyolefins in total, namely, one type of polyolefin as the first polyolefin (a-1) and one type of polyolefin as the second polyolefin (a-2), but another polyolefin may also be included in the base polyolefins as long as the crosslinked product of the resin composition as a whole has a melting point of 80° C. or higher and a flexural modulus of 100 Mpa or less. Also, each of the first polyolefin (a-1) and the second polyolefin (a-2) may include two or more types of polyolefins.

### Unmodified Polyolefin (B)

The unmodified polyolefin (B) is a polyolefin constituted by a hydrocarbon into which no modifying group is introduced through graft polymerization, copolymerization, or the like. Specific examples of the unmodified polyolefin include homopolymers of ethylene and propylene, copolymers of ethylene and α-olefins, copolymers of propylene and α-olefins, and polyolefin elastomers obtained using olefin as the base. Any one of these polyolefins may be used alone or two or more of them may be used in combination. It is preferable to use at least one selected from polyethylene, polypropylene, an ethylene-butene copolymer, and an ethylene-octene copolymer.

Low-density polyethylene (LDPE), linear low-density polyethylene (LLDPE), very-low-density polyethylene (VLDPE), or metallocene low-density polyethylene is preferably used as the polyethylene. Any one of these polyethylenes may be used alone or two or more of them may be used in combination. If these low-density polyethylenes are used, the resin composition and a crosslinked product thereof have particularly high flexibility.

Examples of the polyolefin elastomers include polyolefin-based thermoplastic elastomers (TPO) such as polyethylene-based elastomers (PE elastomers) and polypropylene-based elastomers (PP elastomers), ethylene-propylene rubbers (EPM, EPR), and ethylene-propylene-diene copolymers (EPDM, EPT). If polyolefin elastomers are used, it is possible to impart high flexibility to the resin composition and the crosslinked product thereof.

A polyolefin that is the same as or different from that used in the main chain of the silane-grafted polyolefin (A) may be used as the unmodified polyolefin (B). If the same type of polyolefin is used, the compatibility therebetween is excellent.

The density of the unmodified polyolefin (B) is not particularly limited, but is preferably 0.855 g/cm³ or more, and more preferably 0.860 g/cm³ or more. If the density of the unmodified polyolefin is as described above, the resin composition as a whole and a crosslinked product thereof tend to have a high melting point, and blocking of the resin composition and stickiness of the crosslinked product tend to be suppressed. Also, the density is preferably 0.950 g/cm³ or less, and more preferably 0.940 g/cm³ or less. In this case, the resin composition as a whole and the crosslinked product thereof tend to have high flexibility.

The flexural modulus of the unmodified polyolefin (B) is not particularly limited, but is preferably 200 MPa or less, and more preferably 100 MPa or less. If the flexural modulus of the unmodified polyolefin is as described above, the resin composition as a whole and the crosslinked product thereof tend to have high flexibility. Although a lower limit of the flexural modulus is not particularly set, if the flexural modulus is 3 MPa or more, or 10 MPa or more, the resin composition as a whole and the crosslinked product thereof tend to have a high melting point.

### Modified Polyolefin (C)

The modified polyolefin (C) has one or more functional groups selected from a carboxyl group, an ester group, an acid anhydride group, an amino group, and an epoxy group. The modified polyolefin (C) can be obtained by introducing any of the above-listed functional groups into an unmodified base polyolefin, which is constituted by one or more types of α-olefins, through graft polymerization using a polymerizable compound having the functional group(s). Alternatively, the modified polyolefin (C) can be obtained by copolymerizing a polymerizable compound having any of the above-listed functional groups and an olefin (polymerizable monomer) that can be polymerized with the polymerizable compound to introduce the functional group(s). However, modified polyolefins obtained by introducing a silanol derivative using methacryloxy alkylsilane or the like are classified into the silane-grafted polyolefin (A), and accordingly, are excluded.

The modified polyolefin (C) has one or more functional groups selected from a carboxyl group, an ester group, an acid anhydride group, an amino group, and an epoxy group, and thus has high affinity with inorganic components, and the modified polyolefin (C) has a polyolefin chain, and thus has high affinity with resin components such as the silane-grafted polyolefin (A) and the unmodified polyolefin (B). Therefore, the modified polyolefin (C) functions as a compatibilizer for resin components and inorganic components such as a flame retardant, and improves dispersiveness and adhesiveness of the inorganic components with respect to the resin components.

There is no particular limitation on the polymerizable compound having a carboxyl group as long as the polymerizable compound has a carboxyl group and a polymerizable group such as a carbon-carbon double bond in a molecule. Examples thereof include acrylic acid, methacrylic acid, crotonic acid, α-chloroacrylic acid, itaconic acid, butene tricarboxylic acid, maleic acid, fumaric acid, and derivatives containing these acids in a part of a molecular structure. If these acids form acid anhydride, such acid anhydride may be used to introduce an acid anhydride group.

An ester compound obtained through a reaction between the above-described polymerizable compound having a carboxyl group and an alcohol can be used as the polymerizable compound having an ester group. Alternatively, it is also possible to use an ester compound obtained through a reaction between an alcohol having a carbon-carbon double bond and various carboxylic acids. Examples of such compounds include vinyl acetate and vinyl propionate.

There is no particular limitation on the polymerizable compound having an amino group as long as the polymerizable compound has an amino group and a polymerizable group such as a carbon-carbon double bond in a molecule. Examples thereof include esters obtained through a reaction between the above-described polymerizable compound having a carboxyl group and alkanolamines, vinylamine, allylamine, and derivatives containing structures of these compounds in a part of a molecular structure.

There is no particular limitation on the polymerizable compound having an epoxy group as long as the polymerizable compound has an epoxy group and a polymerizable group such as a carbon-carbon double bond in a molecule. Examples thereof include acid glycidyl esters obtained through a reaction between the above-described polymerizable compound having a carboxyl group and glycidyl alcohol, glycidyl ethers such as vinyl glycidyl ether, allyl glycidyl ether, glycidyloxyethyl vinyl ether, and styrene-p-glycidyl ether, p-glycidyl styrene, and derivatives containing structures of these compounds in a part of a molecular structure.

There is no particular limitation on the polymerizable monomer that can be copolymerized with a polymerizable compound having a functional group such as those listed above, as long as the polymerizable monomer is a compound having a polymerizable group such as a carbon-carbon double bond in a molecule. For example, it is possible to use an olefin monomer having no functional groups, such as ethylene or propylene, or a polymerizable monomer having a functional group other than a carboxyl group and an epoxy group. Any one of these polymerizable monomers may be used alone or two or more of them may be used in combination.

The resin composition according to the present embodiment contains the silane-grafted polyolefin (A), the unmodified polyolefin (B), and the modified polyolefin (C) described above as resin components. There is no particular limitation on the mixing ratio of these resin components, but the silane-grafted polyolefin (A) is preferably contained in an amount of 10 parts by mass or more and 70 parts by mass or less, the unmodified polyolefin (B) is preferably contained in an amount of 20 parts by mass or more and 60 parts by mass or less, and the modified polyolefin (C) is preferably contained in an amount of 1 part by mass or more and 30 parts by mass or less. If the resin components satisfy this mixing ratio, the resin composition and the crosslinked product thereof tend to have a low flexural modulus and a high melting point in a well-balanced manner and have excellent wear resistance. Also, good compatibility and affinity tend to be achieved between the resin components as well as other components contained in the resin composition.

From the viewpoint of simplifying the components of the resin composition according to the present embodiment, the resin composition preferably contains only the above-described components (A) to (C) as the resin components. However, the resin composition may also contain another resin component as long as properties exhibited by these components, such as the low flexural modulus and the high melting point, are not impaired.

### Flame Retardant (D)

The flame retardant (D) improves flame retardancy of the resin composition. As the flame retardant (D), it is possible to use inorganic flame retardants such as metal hydroxides and organic flame retardants such as bromine-based flame retardants. Any type of flame retardant may be used in the resin composition according to the present embodiment. However, it is necessary to add a relatively large amount of flame retardant to impart sufficiently high flame retardancy, and an inorganic flame retardant, or in particular, a metal hydroxide is preferably used as the flame retardant in terms of obtaining a relatively high effect of compensating for a reduction in flexibility as a result of addition of the large amount of flame retardant by using the predetermined resin components.

One or more metal hydroxides may be used as the flame retardant, and examples thereof include magnesium hydroxide, aluminum hydroxide, and zirconium hydroxide. In particular, magnesium hydroxide and aluminum hydroxide are particularly preferable from the viewpoint of cost, for example. The metal hydroxide used as the flame retardant may be treated using a surface treatment agent such as a silane coupling agent, a higher fatty acid, or a polyolefin wax in order to improve dispersiveness in the resin components, for example. However, the resin composition according to the present embodiment contains the modified polyolefin (C) as a resin component, and thus, dispersiveness of the metal hydroxide is high even when surface treatment is not performed.

The metal hydroxide preferably has an average particle size (D50) of 0.5 μm or more. In this case, aggregation of particles is unlikely to occur. Also, the average particle size of the metal hydroxide is preferably 5.0 μm or less. In this case, metal hydroxide particles sufficiently disperse in the resin components. If fine particles of the metal hydroxide are distributed in the resin composition with high uniformity due to suppression of the aggregation and improvement of the dispersiveness, the resin composition exhibits high flame retardancy, and properties exhibited by the resin components, such as the flexibility, are unlikely to be impaired by the metal hydroxide particles.

The metal hydroxide is preferably added in an amount of 30 parts by mass or more with respect to 100 parts by mass of the resin components. In this case, high flame retardancy can be obtained. On the other hand, the addition amount of the metal hydroxide is preferably 150 parts by mass or less with respect to 100 parts by mass of the resin components. In this case, it is possible to improve flexibility of the resin composition while avoiding saturation of the effect of improving flame retardancy.

An organic flame retardant such as a bromine-based flame retardant may also be used as the flame retardant (D) contained in the resin composition, together with or instead of an inorganic flame retardant such as a metal hydroxide. Examples of the bromine-based flame retardant include bromine-based flame retardants having a phthalimide structure, such as ethylene bis(tetrabromophthalimide) and ethylene bis(tribromophthalimide), ethylene bispentabromophenyl, tetrabromobisphenol A (TBBA), hexabromocyclododecane (HBCD), TBBA-carbonate·oligomer, TBBA-epoxy·oligomer, brominated polystyrene, TBBA-bis(dibromopropyl ether), poly(dibromopropyl ether), and hexabromobenzene (HBB). Any one of these flame retardants may be used alone or two or more of them may be used in combination.

When a bromine-based flame retardant is used, it is preferable to use an inorganic flame retardant auxiliary agent such as antimony trioxide to increase the flame retardancy. An average particle size of the antimony trioxide is preferably 3 μm or less, and more preferably 1 μm or less. The antimony trioxide may be treated using a surface treatment agent such as a silane coupling agent, a higher fatty acid, or a polyolefin wax in order to improve dispersiveness, for example.

If a bromine-based flame retardant and an inorganic flame retardant auxiliary agent are used in combination as flame retardant components, the bromine-based flame retardant and the inorganic flame retardant auxiliary agent are preferably contained at an equivalence ratio within a range of bromine-based flame retardant:inorganic flame retardant auxiliary agent=3:1 to 2:1. Also, it is preferable to add 10 to 40 parts by mass of the bromine-based flame retardant and 5 to 20 parts by mass of antimony trioxide with respect to 100 parts by mass of the resin components in the resin composition.

If a metal hydroxide and a bromine-based flame retardant are used in combination as the flame retardant, it is possible to reduce respective amounts of the metal hydroxide and the bromine-based flame retardant, and it is preferable to add 10 to 50 parts by mass of the metal hydroxide, 5 to 20 parts by mass of the bromine-based flame retardant, and 5 to 20 parts by mass of an inorganic flame retardant as necessary with respect to 100 parts by mass in total of the resin components.

### Crosslinking Catalyst (E)

The crosslinking catalyst (E) is a silanol condensation catalyst for silane-crosslinking the silane-grafted polyolefin (A). Examples of the crosslinking catalyst include carboxylates of metals such as tin, zinc, iron, lead, and cobalt, titanic acid esters, organic bases, inorganic acids, and organic acids. Specific examples thereof include dibutyltin dilaurate, dibutyltin dimaleate, dibutyltin bisisooctylthioglycol ester, dibutyltin β-mercaptopropionate, dibutyltin diacetate, dioctyltin dilaurate, stannous acetate, stannous caprylate, lead naphthenate, cobalt naphthenate, barium stearate, calcium stearate, tetrabutyl titanate, tetranonyl titanate, dibutylamine, hexylamine, pyridine, sulfuric acid, hydrochloric acid, toluene sulfonic acid, acetic acid, stearic acid, and maleic acid. Dibutyltin dilaurate, dibutyltin dimaleate, dibutyltin bisisooctylthioglycol ester, and dibutyltin β-mercaptopropionate are preferably used as the crosslinking catalyst.

When the crosslinking catalyst (E) is mixed with the silane-grafted polyolefin (A), a crosslinking reaction proceeds, and thus the crosslinking catalyst is preferably mixed immediately before an electric wire is coated. At this time, in order to improve dispersiveness of the crosslinking catalyst, the crosslinking catalyst is preferably used in the form of a crosslinking catalyst batch obtained by mixing the crosslinking catalyst and a binder resin in advance. If the crosslinking catalyst batch obtained by mixing the crosslinking catalyst and the binder resin in advance is used, the crosslinking catalyst sufficiently disperses and a crosslinking reaction sufficiently progresses while an unintended crosslinking reaction with the silane-grafted polyolefin (A) is prevented. Also, if the crosslinking catalyst batch is used, the addition amount of the crosslinking catalyst can be easily controlled.

A polyolefin that is used in the above-described components (A) to (C) can be used as the binder resin included in the crosslinking catalyst batch. In particular, low-density polyethylene (LDPE), linear low-density polyethylene (LLDPE), very-low-density polyethylene (VLDPE), or metallocene low-density polyethylene is preferably used. If these low-density polyethylenes are used, the electric wire has good flexibility. Alternatively, a portion of the unmodified polyolefin (B) may be used as the binder resin, for example.

The crosslinking catalyst batch preferably contains the crosslinking catalyst in an amount of 0.5 parts by mass or more, or more preferably 1 part by mass or more with respect to 100 parts by mass of the binder resin. In this case, the crosslinking reaction is facilitated. On the other hand, the content of the crosslinking catalyst in the crosslinking catalyst batch is preferably 5 parts by mass or less with respect to 100 parts by mass of the binder resin. In this case, dispersiveness of the catalyst is excellent.

The content of the crosslinking catalyst (E) itself is preferably 0.1 parts by mass or more with respect to 100 parts by mass of the resin components constituting the flame-retardant resin composition. In this case, the crosslinking reaction is facilitated. On the other hand, the content of the crosslinking catalyst is preferably 1.0 part by mass or less. In this case, excessive crosslinking can be prevented.

### Hindered Phenol-Based Antioxidant (F)

Examples of the hindered phenol-based antioxidant (F) include pentaerythritol tetrakis[3-(3,5-di-tert-butyl-4-hydroxyphenyl)propionate], thiodiethylenebis[3-(3,5-di-tert-butyl-4-hydroxyphenyl)propionate], octadecyl-3-(3,5-di-tert-butyl-4-hydroxyphenyl)propionate, N,N′-(hexane-1,6-diyl)bis[3-(3,5-di-tert-butyl-4-hydroxyphenyl)propionamide], 2,4-dimethyl-6-(1-methylpentadecyl) diethyl[[3,5-bis(1,1-dimethylethyl)-4-hydroxyphenyl]methyl]phosphonate, 3,3′,3″,5,5′,5″-hexa-tert-butyl-a,a′,a″-(mesitylene-2,4,6-tolyl)tri-p-cresol, calcium diethyl bis[[[3,5-bis(1, 1-dimethylethyl)-4-hydroxyphenyl]methyl]phosphonate], 4,6-bis(octylthiomethyl)-o-cresol, ethylenebis(oxyethylene) bis[3-(5-tert-butyl-4-hydroxy-m-tolyl)propionate], hexamethylenebis[3-(3,5-di-tert-butyl-4-hydroxyphenyl) propionate, 1,3,5-tris(3,5-di-tert-butyl-4-hydroxybenzyl)-1,3,5-triazine-2,4,6(1H,3H,5H)-trione, 1,3,5-tris[(4-tert-butyl-3-hydroxy-2,6-xylyl)methyl]-1,3,5-triazine-2,4,6(1H,3H,5H)-trio ne, 2,6-tert-butyl-4-(4,6-bis(octylthio)-1,3,5-triazine-2-ylamino)phenol, 2,6-di-tert-butyl-4-methylphenol, 2,2′-methylenebis(4-methyl-6-tert-butylphenol), 4,4′-butylidenebis(3-methyl-6-tert-butylphenol), 4,4′-thiobis(3-methyl-6-tert-butylphenol), and 3,9-bis[2-(3-(3-tert-butyl-4-hydroxy-5-methylphenyl)propinox)-1,1-dimethylethyl]-2,4, 8,10-tetraoxaspiro(5,5)undecane. Any one of these antioxidants may be used alone or two or more of them may be used in combination. Out of these antioxidants, pentaerythritol tetrakis[3-(3,5-di-tert-butyl-4-hydroxyphenyl)propionate] is particularly preferably used.

The hindered phenol-based antioxidant (F) is preferably added in an amount of 0.5 parts by mass or more, or more preferably 1 part by mass or more with respect to 100 parts by mass of the resin components. In this case, an excellent antioxidizing effect can be obtained. On the other hand, the addition amount of the hindered phenol-based antioxidant is preferably 20 parts by mass or less, and more preferably 10 parts by mass or less. In this case, it is possible to suppress the influence of addition of a large amount of antioxidant, such as blooming, on the resin composition.

### Metal Oxide (G)

Heat resistance of the resin composition can be improved by adding a metal oxide to the resin composition. Examples of metal oxides that have a high effect of improving heat resistance include zinc oxide, aluminum oxide, potassium oxide, calcium oxide, barium oxide, and magnesium oxide. In particular, zinc oxide is preferably used, and the average particle size of the zinc oxide is preferably 3 μm or less, and more preferably 1 μm or less.

The metal oxide (G) is preferably added in an amount of 0.5 parts by mass or more, or more preferably 1 part by mass or more with respect to 100 parts by mass of the resin components. In this case, the effect of improving heat resistance is high. On the other hand, the addition amount of the metal oxide is preferably 15 parts by mass or less, and more preferably 10 parts by mass or less. In this case, aggregation of metal oxide particles is unlikely to occur, and the dispersiveness of the metal oxide in the resin components is high.

### Sulfur-Based Antioxidant (H)

Oxidation of the resin composition can be suppressed and heat resistance of the resin composition can be improved by adding the sulfur-based antioxidant (H) to the resin composition. Although there is no particular limitation on the type of sulfur-based antioxidant (H), an imidazole-based compound is preferably used.

Examples of imidazole-based compounds that can be used as the antioxidant include mercaptobenzimidazoles. Examples of the mercaptobenzimidazoles include 2-mercaptobenzimidazole, 2-mercaptomethylbenzimidazole, 4-mercaptomethylbenzimidazole, 5-mercaptomethylbenzimidazole, and zinc salts of these compounds. 2-mercaptobenzimidazole and zinc salts thereof are particularly preferable because they are stable at high temperature due to a high melting point and less sublimation during mixing.

The sulfur-based antioxidant (H) is preferably added in an amount of 0.5 parts by mass or more, or more preferably 1 part by mass or more with respect to 100 parts by mass of the resin components. In this case, it is possible to obtain a high antioxidation effect and a high effect of improving heat resistance. On the other hand, the addition amount of the sulfur-based antioxidant is preferably 20 parts by mass or less, and more preferably 15 parts by mass or less. In this case, it is possible to suppress the influence of addition of a large amount of antioxidant, such as blooming, on the resin composition.

### Lubricant (I)

The lubricant (I) imparts a lubrication effect to the resin composition. Either an internal lubricant or an external lubricant may be used. There is no particular limitation on the type of compound that is used as the lubricant, and examples thereof include hydrocarbons such as liquid paraffin, paraffin wax, and polyethylene wax, fatty acids such as stearic acid, oleic acid, and erucic acid, higher alcohols, fatty acid amides such as stearic acid amides, oleic acid amides, and erucic acid amides, alkylene fatty acid amides such as methylene bis stearamides and ethylene bis stearamides, and metal soaps such as metal stearates, and ester-based lubricants such as monoglyceride stearate, stearyl stearate, and hardened oil. From the viewpoint of compatibility with the resin components, fatty acids such as erucic acid, oleic acid, and stearic acid, derivatives of these acids, or polyethylene-based wax is preferably used as the lubricant.

The lubricant (I) is preferably added in an amount of 0.1 parts by mass or more with respect to 100 parts by mass of the resin components. In this case, a high lubrication effect can be obtained. On the other hand, the addition amount of the lubricant is preferably 5 parts by mass or less.

Furthermore, the flame-retardant resin composition according to the present embodiment may also contain various additives within a range in which properties such as flexibility and the high melting point are not impaired. Examples of additives include a metal deactivator, an inorganic filler, a pigment, and silicone oil. Examples of the metal deactivator include a copper deactivator and a chelating agent, and specific examples thereof include hydrazide derivatives such as 2,3-bis[3-(3,5-di-tert-butyl-4-hydroxyphenyl)propionyl]propionohydrazide and salicylic acid derivatives such as 3-(N-salicyloyl)amino-1,2,4-triazole. Examples of the inorganic filler include calcium carbonate. The inorganic filler is preferably added in an amount of 30 parts by mass or less with respect to 100 parts by mass in total of the resin components from the viewpoint of the resin strength.

### [2] Properties of Resin Composition

As described above, a crosslinked product formed from the resin composition according to the present embodiment by silane crosslinking has a melting point as high as 80° C. or higher and a flexural modulus as low as 100 MPa or less. The high melting point and the low flexural modulus of the crosslinked product indicate that the resin composition also has a high melting point and a low flexural modulus before crosslinking. Note that even if the crosslinked product is heated to a temperature equal to or higher than the melting point, the resin does not flow, but a heat absorption peak appears in DSC, and the temperature at the peak top is taken as the melting point of the crosslinked product. The melting point of the crosslinked product is almost the same as the melting point of the resin composition before crosslinking, and accordingly, it is preferable that the resin composition before crosslinking has a melting point of 80° C. or higher.

Since the resin composition has a low flexural modulus that leads to a flexural modulus of 100 MPa or less of the crosslinked product, the resin composition before crosslinking and the crosslinked product formed by silane crosslinking have high flexibility. Since the resin composition has high flexibility, the resin composition and the crosslinked product thereof can be suitably used for products that are frequently bent, such as a coating material of an insulated electric wire.

At the same time, the resin composition has a high melting point that leads to a melting point of 80° C. or higher of the crosslinked product, and accordingly, the resin composition is unlikely to melt or be softened by heat, and blocking is unlikely to occur at temperatures around room temperature, for example. Also, the surface of the crosslinked product is unlikely to be sticky at temperatures around room temperature. Blocking of the resin composition and stickiness of the crosslinked product impair handleability of the resin composition and the crosslinked product at room temperature. However, these phenomena are suppressed, and therefore, handleability of the resin composition and the crosslinked product at room temperature is high. When a product such as an insulated electric wire is manufactured using the resin composition, blocking can be suppressed before the resin composition is crosslinked in the manufacturing process and stickiness of the completed product can be suppressed after the resin composition is crosslinked, and thus high handleability can be obtained.

As described above, the resin composition has high flexibility and high handleability and forms a crosslinked product having a melting point of 80° C. or higher and a flexural modulus of 100 MPa or less. The melting point of the crosslinked product is more preferably 100° C. or higher, and even more preferably 110° C. or higher. The flexural modulus of the crosslinked product is more preferably less than 90 MPa, and even more preferably less than 80 MPa.

Note that the resin composition contains at least three types of polyolefins as the components (A) to (C), but when the melting point of the crosslinked product of the resin composition is measured using DSC, a single heat absorption peak is usually observed. The temperature at the single peak top, which is taken as the melting point, is 80° C. or higher. However, if a plurality of heat absorption peaks are observed, the temperature of a peak top that is the lowest among temperatures of the plurality of peaks is taken as the melting point, and that melting point is 80° C. or higher. Although a component other than the resin components may have a melting point lower than 80° C., it is preferable that each component other than the resin components contained in the crosslinked product does not have a melting point lower than 80° C.

### [3] Method for Manufacturing Resin Composition

The resin composition according to the present embodiment can be prepared by blending and kneading the components (A) to (E) and various additive components that are added as needed, using a twin-screw extrusion kneader or the like, for example. However, when the silane-grafted polyolefin (A) and the crosslinking catalyst (E) are mixed, a crosslinking reaction proceeds due to moisture in the air. From the viewpoint of preventing a crosslinking reaction and other unintended reactions during storage, for example, it is preferable to mix the components immediately before an electric wire is coated. As such a method, it is preferable to prepare and pelletize a silane-grafted batch, a flame retardant batch, and a crosslinking catalyst batch.

The silane-grafted batch contains the silane-grafted polyolefin (A). The flame retardant batch contains the unmodified polyolefin (B), the modified polyolefin (C), and the flame retardant (D). The crosslinking catalyst batch contains the crosslinking catalyst (E) and the binder resin. The components (F) to (I) and various other additive components that are added as needed may be contained in any of the silane-grafted batch, flame retardant batch, and the crosslinking catalyst batch as long as properties of the components constituting the respective batches are not inhibited.

### [4] Other Embodiments

Here, a flame-retardant resin composition according to a modified embodiment will be briefly described. In the embodiment described above, it is specified that the crosslinked product formed from the resin composition has a melting point of 80° C. or higher and a flexural modulus of 100 MPa or more, as a whole. However, even in the modified embodiment in which the resin composition does not necessarily form a crosslinked product having such a melting point and/or a flexural modulus, if a first polyolefin (a-1) and a second polyolefin (a-2) described below are used as base polyolefin resins that constitute the silane-grafted polyolefin (A), the resin composition can have both high flexibility and high handleability.

First polyolefin (a-1): polyolefin having a density of 0.870 g/cm³ or less, a melting point of 110° C. or higher, and a flexural modulus of 11 MPa or less Second polyolefin (a-2): polyolefin having a density of 0.870 g/cm³ or less, a melting point of 60° C. or lower, and a flexural modulus of 11 MPa or less Here, the first polyolefin (a-1) and the second polyolefin (a-2) are mixed at a mass ratio (a-1)/(a-2) within a range of 30/70 or more and 70/30 or less.

Both the first polyolefin (a-1) and the second polyolefin (a-2) have a low density and a low flexural modulus, and therefore, the silane-grafted polyolefin (A) as a whole, the resin composition as a whole, and the crosslinked product as a whole have a low flexural modulus, and accordingly have high flexibility. On the other hand, the first polyolefin (a-1) has a high melting point, and therefore, the silane-grafted polyolefin (A) as a whole, the resin composition as a whole, and the crosslinked product as a whole have a high melting point, and accordingly, their handleability at room temperature is high.

In general, when a silane-grafted polyolefin is obtained using a polyolefin having a low melting point and the silane-grafted polyolefin is crosslinked, the crosslinked product tends to have a low flexural modulus. Therefore, in the case where the silane-grafted polyolefin is obtained using the single polyolefin, it may be difficult for the resin composition as a whole to have a low flexural modulus and a high melting point both satisfying desired levels. However, if the above-described first polyolefin (a-1) and second polyolefin (a-2) having mutually different melting points are mixed to obtain the silane-grafted polyolefin (A), it becomes easy to realize both a high melting point and a low flexural modulus of the resin composition and the crosslinked product.

The preferable material compositions and properties of the silane-grafted polyolefin (A) described in detail in the above embodiment can be suitably applied to the silane-grafted polyolefin (A) that is included in the resin composition according to this modified embodiment and contains the first polyolefin (a-1) and the second polyolefin (a-2) as base polyolefins. Also, the preferable material compositions and properties of the components other than the silane-grafted polyolefin (A) described in detail in the above embodiment can be suitably applied to corresponding components included in the resin composition.

### Insulated Electric Wire and Wire Harness

Next, an insulated electric wire according to an embodiment of the present disclosure and a wire harness according to an embodiment of the present disclosure will be described.

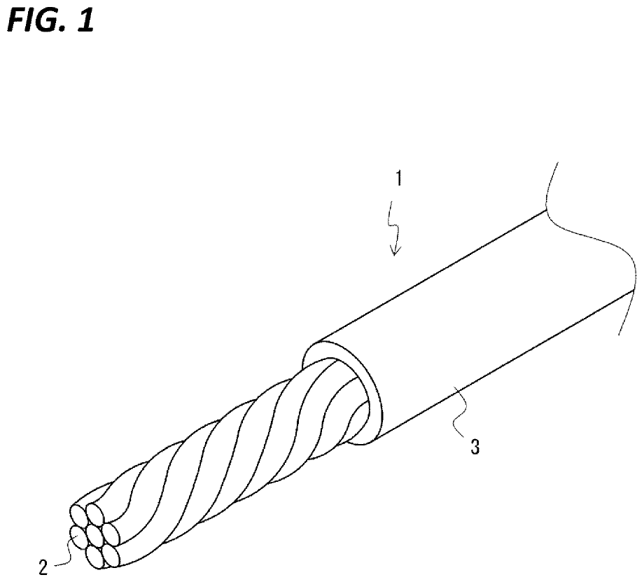

As shown in FIG. 1, an insulated electric wire 1 according to the present embodiment includes a conductor 2 and an electric wire coating material (also simply referred to as “coating material”) 3 covering the outer circumference of the conductor 2. The electric wire coating material 3 is constituted by a crosslinked product obtained by crosslinking the flame-retardant resin composition according to the above-described embodiment of the present disclosure.

There is no particular limitation on the diameter and the material of the conductor 2 of the insulated electric wire 1, and the diameter and material thereof can be selected as appropriate depending on the application of the insulated electric wire 1, for example. Examples of the material of the conductor 2 include metal materials such as copper, a copper alloy, aluminum, and an aluminum alloy. From the viewpoint of reducing the weight of the electric wire, aluminum or an aluminum alloy is preferable. The electric wire coating material 3 may include a single layer or two or more layers.

The insulated electric wire 1 can be manufactured by crosslinking the resin composition according to an embodiment of the present disclosure on the outer circumference of the conductor 2. For example, the insulated electric wire can be manufactured by kneading the above-described silane-grafted batch, flame retardant batch, and crosslinking catalyst batch using a common kneader such as a Banbury mixer, a pressure kneader, a kneading extruder, a twin-screw extruder, or a roller, while heating the batches, and extruding the resultant resin composition onto the outer circumference of the conductor 2 using an extrusion machine or the like to coat the conductor 2, and then crosslinking the resin composition.

As a method for crosslinking the coating material 3, the coating layer of the coated electric wire can be exposed to water vapor or water. At this time, the coating layer is preferably brought into contact with water vapor or water in a temperature range from room temperature to 90° C. for 48 hours or less. More preferably, the coating layer is brought into contact with water vapor or water in a temperature range from 50° C. to 80° C. for 8 hours or more and 24 hours or less.

The wire harness of according to an embodiment of the present disclosure includes the above-described insulated electric wire 1. The wire harness may be a single electric wire bundle obtained by bundling only the insulated electric wires 1, or a mixed electric wire bundle obtained by bundling the insulated electric wire 1 and other insulated electric wires in a mixed state. The electric wire bundle is configured as the wire harness by bundling electric wires with a wire harness protecting material such as a corrugate tube, a binding material such as adhesive tape, or the like.

The insulated electric wire 1 according to the embodiment of the present disclosure can be used alone or in the state of the wire harness as various electric wires for automobiles, electric or electronic devices, information communication, power supply, ships, aircraft, and the like. In particular, the insulated electric wire can be suitably used as an electric wire for automobiles.

### EXAMPLES

The following describes examples. However, the present invention is not limited to the following examples. Here, flame-retardant resin compositions having various compositions were prepared, and their properties were compared.

### Test Method

### [1] Materials Used

### Silane-Grafted Polyolefin (A)

First, silane-grafted polyolefins (A) were prepared as raw materials of the resin compositions. First, six types of polyolefins (PE1 to PE6) shown in Table 1 below were prepared, and one or two of them were selected as shown in Table 2 below. In cases where two types of polyolefins were selected, the two types of polyolefins were blended at a mass ratio shown in Table 2, and were kneaded at 140° C. using a single-screw kneader. The kneaded base polyolefins and each base polyolefin used alone were subjected to silane grafting to obtain silane-grafted polyolefins (A) (silane-grafted PE1 to PE14). Silane grafting was performed by kneading a dry-blended material including 1.5 parts by mass of vinyltrimethoxysilane (“KBM1003” manufactured by Shin-Etsu Chemical Co., Ltd.) and 0.15 parts by mass of dicumyl peroxide (“PERCUMYL D” manufactured by NOF CORPORATION) with respect to 100 parts by mass of the base polyolefin(s), at 140° C. using a single-screw kneader.

Table 1 below shows specific product names of the polyolefins (PE1 to PE6) used as raw materials, and densities, melting points, and flexural moduluses thereof.

TABLE 1

| Raw | | | Melting | Flexural |
|---|---|---|---|---|
| material | | Density | point | modulus |
| polyolefin | Product | [g/cm³] | [° C.] | [MPa] |
| PE1 | “INFUSE 9107” | 0.866 | 121 | 7 |
| | manufactured by Dow Elastomers | | | |
| PE2 | “ENGAGE XLT8677” | 0.870 | 118 | 6 |
| | manufactured by Dow Elastomers | | | |
| PE3 | “ENGAGE 8842” | 0.857 | 38 | 4 |
| | manufactured by Dow Elastomers | | | |
| PE4 | “ENGAGE 8200” | 0.870 | 59 | 11 |
| | manufactured by Dow Elastomers | | | |
| PE5 | “ENGAGE 7367” | 0.874 | 51 | 14 |
| | manufactured by Dow Elastomers | | | |
| PE6 | “ENGAGE 8003” | 0.885 | 77 | 32 |
| | manufactured by Dow Elastomers | | | |

Table 2 below shows blending ratios of the raw materials of the silane-grafted polyolefins (silane-grafted PE1 to PE14) in the unit of parts by mass. Also, Table 2 shows melting points and flexural moduluses measured after the base polyolefins were subjected to grafting. Here, the melting point was measured using DSC in accordance with JIS K7121. FIG. 2 shows a DSC curve of the silane-grafted PE1 as an example. This measurement result shows a single peak around 121° ° C., which corresponds to melting. As for all of the silane-grafted PE1 to PE14, a single peak corresponding to melting was observed, and a temperature at the peak top was taken as the melting point. The flexural modulus was measured in accordance with ASTM D790.

TABLE 2

| | Silane- | Silane- | Silane- | Silane- | Silane- | Silane- | Silane- |
|---|---|---|---|---|---|---|---|
| | grafted | grafted | grafted | grafted | grafted | grafted | grafted |
| | PE1 | PE2 | PE3 | PE4 | PE5 | PE6 | PE7 |
| PE1 | 30 | 40 | | | | 42 | 18 |
| PE2 | | | 20 | 30 | 30 | | |
| PE3 | 30 | | 40 | | 30 | 18 | 42 |
| PE4 | | 20 | | 30 | | | |
| PE5 | | | | | | | |
| PE6 | | | | | | | |
| Vinylmethoxysilane | 1.5 | 1.5 | 1.5 | 1.5 | 1.5 | 1.5 | 1.5 |
| Dicumyl peroxide | 0.15 | 0.15 | 0.15 | 0.15 | 0.15 | 0.15 | 0.15 |
| Melting point [° C.] | 120 | 119 | 117 | 118 | 118 | 120 | 119 |
| Flexural modulus [MPa] | 6 | 9 | 5 | 8 | 5 | 6 | 5 |
| | Silane- | Silane- | Silane- | Silane- | Silane- | Silane- | Silane- |
| | grafted | grafted | grafted | grafted | grafted | grafted | grafted |
| | PE8 | PE9 | PE10 | PE11 | PE12 | PE13 | PE14 |
| PE1 | 20 | | | | 60 | | |
| PE2 | | 30 | 50 | 10 | | | |
| PE3 | | | 10 | 50 | | 60 | |
| PE4 | | | | | | | |
| PE5 | 40 | | | | | | |
| PE6 | | 30 | | | | | 60 |
| Vinylmethoxysilane | 1.5 | 1.5 | 1.5 | 1.5 | 1.5 | 1.5 | 1.5 |
| Dicumyl peroxide | 0.15 | 0.15 | 0.15 | 0.15 | 0.15 | 0.15 | 0.15 |
| Melting point [° C.] | 118 | 116 | 117 | 116 | 121 | 38 | 76 |
| Flexural modulus [MPa] | 12 | 20 | 6 | 5 | 9 | 4 | 31 |

### Unmodified Polyolefin (B)

The following substances were prepared as unmodified polyolefins (unmodified PE1 to PE3 and PP1).
Unmodified PE1: “ENGAGE 7467” (density: 0.862 g/cm³, flexural modulus: 4 MPa) manufactured by Dow Elastomers
Unmodified PE2: “ENGAGE 7256” (density: 0.885 g/cm³, flexural modulus: 30 MPa) manufactured by Dow Elastomers
Unmodified PE3: “NOVATEC HDHY331” (density: 0.951 g/cm³, flexural modulus: 1050 MPa) manufactured by Japan Polypropylene Corporation
Unmodified PP1: “NEWCON NAR6” (density: 0.890 g/cm³, flexural modulus: 550 MPa) manufactured by Japan Polypropylene Corporation

### Modified Polyolefin (C)

The following substances were prepared as modified polyolefins (modified PE1, PE2, and PP).
Modified PE1: “Modic AP512P” (maleic anhydride-modified polyethylene) manufactured by Mitsubishi Chemical Corporation
Modified PE2: “BONDFAST E” (glycidyl methacrylate-modified polyethylene) manufactured by SUMITOMO CHEMICAL COMPANY, LIMITED
Modified PP: “ADMER QB550” (maleic anhydride-modified polypropylene) manufactured by Mitsui Chemicals, Inc.

Components other than those listed above were as follows.

### Flame Retardant (D)

Magnesium hydroxide: “Granifin H10” manufactured by Albemarle Corporation
Aluminum hydroxide: “C305” manufactured by SUMITOMO CHEMICAL COMPANY, LIMITED

### Crosslinking Catalyst (E)

Crosslinking catalyst batch: “Linklon LZ082” (crosslinking catalyst content: 1%, binder resin: polyethylene with a density of 0.91 g/cm3) manufactured by Mitsubishi Chemical Corporation

### Hindered Phenol-Based Antioxidant (F)

“IRGANOX 1010” manufactured by BASF Japan

### Metal Oxide (G)

Zinc oxide: “Zinc oxide type 1” manufactured by HAKUSUI TECH CO., LTD.

### Sulfur-Based Antioxidant (H)

Imidazole compound: “ANTAGE MB” (2-mercaptobenzimidazole) manufactured by Kawaguchi Chemical Industry Co., LTD.

### Lubricant (I)

“ALFLOW P10” (erucic acid amide) manufactured by Nippon Oil & Fats Co., Ltd.

### Other Components

Metal deactivator: “CDA-1” manufactured by ADEKA Corporation

### [2] Manufacture of Samples

### Preparation of Silane-Grafted Batches

Silane-grafted batches were prepared by pelletizing the silane-grafted polyolefins.

### Preparation of Crosslinking Catalyst Batch “Linklon LZ082” manufactured by Mitsubishi Chemical Corporation, which was supplied in the form of pellets, was used as a crosslinking catalyst batch.

### Preparation of Flame Retardant Batches

Out of components shown in Tables 3 and 4, components other than the silane-grafted polyolefins and the crosslinking catalyst batch (the crosslinking catalyst and the binder resin) were loaded into a twin-screw kneader, kneaded while being heated at 200° C. for about 0.1 to 2 minutes to be sufficiently dispersed, and then pelletized to obtain flame retardant batches.

### Production of Test Pieces

Resin compositions of samples A1 to A14, B1, and B2 were prepared by blending the components at blending ratios shown in Tables 3 and 4. At this time, the silane-grafted batches, the flame retardant batches, and the crosslinking catalyst batch prepared as described above were kneaded at 200° ° C.using a twin-screw kneader, and formed into strip-shaped test pieces through compression molding. Thereafter, the test pieces were crosslinked for 12 hours in a thermohygrostat bath at a humidity of 95% and a temperature of 65° C., and then dried for 24 hours at room temperature to obtain crosslinked test pieces.

In addition to the above, insulated electric wires were produced for a test by using the resin compositions having the blending ratios shown in Tables 3 and 4. At this time, the silane-grafted batches, the flame retardant batches, and the crosslinking catalyst batch prepared as described above were mixed using a hopper of an extrusion machine, and extruded with the temperature of the extrusion machine set to 200° C. The extrusion was performed to cover a conductor with an outer diameter of 2.4 mm with an insulating coating material extruded with a thickness of 0.7 mm onto the conductor. Thereafter, a crosslinking treatment was performed for 24 hours in a thermohygrostat bath at a humidity of 95% and a temperature of 65° C. to obtain insulated electric wires.

### [3] Evaluation Methods

Physical Properties of Crosslinked Product The melting point and the flexural modulus were measured for each of the crosslinked test pieces produced as described above.

### Melting Point

The melting point was measured using DSC in accordance with JIS K7121. A melting point of 80° C. or higher was evaluated as high (A), and a melting point of 110° C. or higher was evaluated as particularly high (A+). On the other hand, a melting point lower than 80° ° C.was evaluated as low (B).

### Flexural Modulus

The flexural modulus was measured in accordance with ASTM D790. A flexural modulus of 100 MPa or less was evaluated as low (A), and a flexural modulus less than 80 MPa was evaluated as particularly low (A+). On the other hand, a flexural modulus more than 100 MPa was evaluated as high (B).

### Properties of Insulated Electric Wire

The insulated electric wires produced for a test as described above were evaluated in terms of resistance to melting, flexibility, and wear resistance.

### Resistance to Melting

In the above-described production of the insulated wires, each insulated wire was wound around a reel having an outer diameter of 600 mm after the conductor of the electric wire was covered with the extruded insulating coating material and before the crosslinking treatment was performed. In this state, the insulated electric wire was subjected to crosslinking treatment for 24 hours in a thermohygrostat bath at a humidity of 95% and a temperature of 65° C. Thereafter, the insulated electric wire was unwounded from the reel, and the unwounded portion was visually checked to confirm whether or not there was a melted portion. If no melting mark was observed in the visual check on the surface of the coating material in portions of the insulated electric wire that had been in contact with each other while being wounded around the reel, the resistance to melting was evaluated as high (A). In this case, it can be determined that blocking of the resin composition before crosslinking will not occur and a crosslinked product will not have a sticky surface. On the other hand, if a melting mark was observed in the visual check, the resistance to melting was evaluated as low (B).

### Flexibility

Three-point bending flexibility was evaluated based on JIS K7171. The crosslinked insulated electric wire was cut to obtain three pieces of the insulated electric wire each having a length of 100 mm, the pieces of the insulated electric wire were arranged side by side and fixed together at two ends using polyvinyl chloride tape to obtain a test piece. The test piece was set on a jig including a pair of columns spaced apart from each other by a distance of 50 mm. Then, a position on the test piece corresponding to the midpoint between the columns was pressed from above at a speed of 1 mm/min to measure a maximum load applied to the test piece. If the maximum load was 4 N or less, flexibility was evaluated as high (A), and if the maximum load was 2 N or less, flexibility was evaluated as particularly high (A+). On the other hand, if the maximum load was more than 4 N, flexibility was evaluated as low (B).

### Wear Resistance

An abrasion test was performed in accordance with ISO 6722. An iron wire having an outer diameter of 0.45 mm was pressed against the crosslinked insulated electric wire with a load of 7 N and moved back and forth at a speed of 55 times/min and the number of times the iron wire was moved back and forth until electricity was conducted between the iron wire and copper constituting the conductor was counted. If the number was 500 or more, wear resistance was evaluated as high (A), and if the number was 700 or more, wear resistance was evaluated as particularly high (A+). On the other hand, if the number was less than 500, wear resistance was evaluated as low (B).

### [4] Test Results

Tables 3 and 4 below show blending ratios of the components of the samples A1 to A14, B1, and B2 in the unit of parts by mass, and evaluation results of the samples.

TABLE 3

| Sample No. | | | A1 | A2 | A3 | A4 | A5 | A6 | A7 |
|---|---|---|---|---|---|---|---|---|---|
| (A) | Silane-grafted PE1 | | 60 | | | | | | |
| | Silane-grafted PE2 | | | 60 | | | | | |
| | Silane-grafted PE3 | | | | 60 | | | | |
| | Silane-grafted PE4 | | | | | 60 | | | |
| | Silane-grafted PE5 | | | | | | 60 | | |
| | Silane-grafted PE6 | | | | | | | 60 | |
| | Silane-grafted PE7 | | | | | | | | 60 |
| | Silane-grafted PE8 | | | | | | | | |
| | Silane-grafted PE9 | | | | | | | | |
| | Silane-grafted PE10 | | | | | | | | |
| | Silane-grafted PE11 | | | | | | | | |
| | Silane-grafted PE12 | | | | | | | | |
| | Silane-grafted PE13 | | | | | | | | |
| | Silane-grafted PE14 | | | | | | | | |
| (B) | Unmodified PE1 | | 30 | 30 | | 30 | 30 | | 30 |
| | Unmodified PE2 | | | | 30 | | | 30 | |
| | Unmodified PE3 | | | | | | | | |
| | Unmodified PP1 | | | | | | | | |
| (C) | Modified PE1 | | 10 | 10 | | 10 | 10 | | 10 |
| | Modified PE2 | | | | 10 | | | | |
| | Modified PP | | | | | | | 10 | |
| (D) | Magnesium hydroxide | | 90 | 90 | 90 | | 90 | | 90 |
| | Aluminum hydroxide | | | | | 90 | | 90 | |
| (E) | Crosslinking catalyst | | 5 | 5 | 5 | 5 | 5 | 5 | 5 |
| | batch | | | | | | | | |
| (F) | Hindered phenol-based | | 1 | 1 | 1 | 1 | 1 | 1 | 1 |
| | antioxidant | | | | | | | | |
| (G) | Metal oxide | | 5 | 5 | 5 | 5 | 5 | 5 | 5 |
| (H) | Sulfur-based antioxidant | | 5 | 5 | 5 | 5 | 5 | 5 | 5 |
| (I) | Lubricant | | 0.5 | 0.5 | 0.5 | 0.5 | 0.5 | 0.5 | 0.5 |
| | Metal deactivator | | 0.5 | 0.5 | 0.5 | 0.5 | 0.5 | 0.5 | 0.5 |
| Evaluation | Crosslinked | Melting | A+ | A+ | A+ | A+ | A+ | A+ | A+ |
| results | product | point | | | | | | | |
| | | Flexural | A+ | A+ | A+ | A+ | A+ | A+ | A+ |
| | | modulus | | | | | | | |
| | Insulated | Resistance | A | A | A | A | A | A | A |
| | electric | to melting | | | | | | | |
| | wire | Flexibility | A+ | A+ | A+ | A+ | A+ | A+ | A+ |
| | | Wear | A+ | A+ | A+ | A+ | A+ | A+ | A+ |
| | | resistance | | | | | | | |

TABLE 4

| Sample No. | | | A8 | A9 | A10 | A11 | A12 | A13 | A14 | B1 | B2 |
|---|---|---|---|---|---|---|---|---|---|---|---|
| (A) | Silane-grafted PE1 | | | | | | 60 | 60 | | | |
| | Silane-grafted PE2 | | | | | | | | | | |
| | Silane-grafted PE3 | | | | | | | | | | |
| | Silane-grafted PE4 | | | | | | | | | | |
| | Silane-grafted PE5 | | | | | | | | | | |
| | Silane-grafted PE6 | | | | | | | | | | |
| | Silane-grafted PE7 | | | | | | | | | | |
| | Silane-grafted PE8 | | 60 | | | | | | | | |
| | Silane-grafted PE9 | | | 60 | | | | | | | |
| | Silane-grafted PE10 | | | | 60 | | | | | | |
| | Silane-grafted PE11 | | | | | 60 | | | | | |
| | Silane-grafted PE12 | | | | | | | | 60 | | |
| | Silane-grafted PE13 | | | | | | | | | 60 | |
| | Silane-grafted PE14 | | | | | | | | | | 60 |
| (B) | Unmodified PE1 | | 30 | 30 | 30 | 30 | | | 30 | 30 | 30 |
| | Unmodified PE2 | | | | | | | | | | |
| | Unmodified PE3 | | | | | | 30 | | | | |
| | Unmodified PP1 | | | | | | | 30 | | | |
| (C) | Modified PE1 | | 10 | 10 | 10 | 10 | 10 | 10 | 10 | 10 | 10 |
| | Modified PE2 | | | | | | | | | | |
| | Modified PP | | | | | | | | | | |
| (D) | Magnesium hydroxide | | 90 | 90 | 90 | 90 | 90 | 90 | 90 | 90 | 90 |
| | Aluminum hydroxide | | | | | | | | | | |
| (E) | Crosslinking catalyst batch | | 5 | 5 | 5 | 5 | 5 | 5 | 5 | 5 | 5 |
| (F) | Hindered phenol-based | | 1 | 1 | 1 | 1 | 1 | 1 | 1 | 1 | 1 |
| | antioxidant | | | | | | | | | | |
| (G) | Metal oxide | | 5 | 5 | 5 | 5 | 5 | 5 | 5 | 5 | 5 |
| (H) | Sulfur-based antioxidant | | 5 | 5 | 5 | 5 | 5 | 5 | 5 | 5 | 5 |
| (I) | Lubricant | | 0.5 | 0.5 | 0.5 | 0.5 | 0.5 | 0.5 | 0.5 | 0.5 | 0.5 |
| | Metal deactivator | | 0.5 | 0.5 | 0.5 | 0.5 | 0.5 | 0.5 | 0.5 | 0.5 | 0.5 |
| Evaluation | Crosslinked | Melting | A+ | A+ | A+ | A | A+ | A+ | A+ | B | B |
| results | product | point | | | | | | | | | |
| | | Flexural | A | A | A | A+ | A | A | A | A+ | B |
| | | modulus | | | | | | | | | |
| | Insulated | Resistance | A | A | A | A | A | A | A | B | B |
| | electric wire | to melting | | | | | | | | | |
| | | Flexibility | A | A | A | A+ | A | A | A | A+ | B |
| | | Wear | A+ | A+ | A+ | A | A+ | A+ | A+ | A | A |
| | | resistance | | | | | | | | | |

In all of the samples A1 to A14, the crosslinked product had a melting point of 80° C. or higher (A or A+) and a flexural modulus of 100 MPa or less (A or A+). In correspondence with these results, the insulated electric wire had high resistance to melting (A) and high flexibility (A or A+) at the same time. Based on this correspondence between evaluation results, it seems that a high melting point of the crosslinked product leads to high resistance to melting and a low flexural modulus of the crosslinked product leads to high flexibility. These samples also had high wear resistance (A or A+).

Out of the samples A1 to A14, the following focuses on the samples A1 to A7. In these samples, a first polyolefin (a-1) having a density of 0.870 g/cm³ or less, a melting point of 110° C. or higher, and a flexural modulus of 11 MPa or less, namely, PE1 or PE2 was mixed with a second polyolefin (a-2) having a density of 0.870 g/cm³ or less, a melting point of 60° C. or lower, and a flexural modulus of 11 MPa or less, namely, PE3 or PE4 at a mass ratio (a-1)/(a-2) within a range from 30/70 to 70/30, and these polyolefins were used as base polyolefins of the silane-grafted polyolefin (A). Also, an unmodified polyolefin (B) having a density of 0.950 g/cm³ or less and a flexural modulus of 200 MPa or less, namely, the unmodified PE1 or PE2 was used. As a result of the use of the two types of base polyolefins having different melting points in the silane-grafted polyolefin (A) and the unmodified polyolefin (B) having a predetermined low density and a predetermined low flexural modulus, the crosslinked product had a particularly low flexural modulus (A+) of less than 80 MPa and a particularly high melting point (A+) of 110° C. or higher. Also, the insulated electric wire had high resistance to melting (A) and particularly high flexibility (A+).

On the other hand, in the samples A8 to A11 and A14, the base polyolefins of the silane-grafted polyolefin (A) were not a mixture of the above-described first polyolefin (a-1) and the above-described second polyolefin (a-2) mixed at a mass ratio (a-1)/(a-2) within the range from 30/70 to 70/30. In the samples A8 and A9, polyolefins (PE5 and PE6) having a high density and a high flexural modulus were used instead of the second polyolefin (a-2). In the sample A10, the content of the second polyolefin (a-2) was lower than that satisfying the mixing ratio (a-1)/(a-2) of 70/30. As described above, in the samples A8 to A10, the second polyolefin (a-2) having a low density, a low flexural modulus, and a low melting point was not contained as the base polyolefin of the silane-grafted polyolefin (A), or was contained but the content was not sufficiently high. It seems that therefore, the flexural modulus was not as low as that achieved in the samples A1 to A7, and flexibility was not as high as that achieved in the samples A1 to A7.

In the sample A11, the content of the first polyolefin (a-1) was lower than that satisfying the mixing ratio (a-1)/(a-2) of 30/70. The sample A11 did not contain a sufficiently large amount of the first polyolefin (a-1) having a low density, a low flexural modulus, and a high melting point, as the base polyolefin of the silane-grafted polyolefin (A). It seems that therefore, the melting point of the crosslinked product was not as high as that achieved in the samples A1 to A7. Also, the wear resistance did not reach the particularly high level.

In the sample A14, the silane-grafted polyolefin (A) (silane-grafted polyolefin PE12) constituted by only one base polyolefin (PE1) was used. As shown in Table 2, the silane-grafted polyolefin PE12 has a high melting point and a relatively low flexural modulus, and accordingly, the flexural modulus was suppressed to some extent and flexibility was improved to some extent in the sample A14. However, the flexural modulus was not as low as that achieved in the samples A1 to A7 in which the silane-grafted polyolefin (A) was constituted by a mixture of the two types of base polyolefins (a-1) and (a-2), and the flexibility was not as high as that achieved in the samples A1 to A7.

In the samples A12 and A13, an unmodified polyolefin (B) (unmodified PE3 or PP1) that does not have at least either a density of 0.950 g/cm³ or less or a flexural modulus of 200 MPa or less was used. It seems that therefore, the flexural modulus was not as low as that achieved in the samples A1 to A7 in which an unmodified polyolefin having a low density and a low flexural modulus was used, and the flexibility was not as high as that achieved in the samples A1 to A7.

Lastly, in the samples B1 and B2, a silane-grafted polyolefin (A) (silane-grafted polyolefin PE13 or PE14) containing only one base polyolefin (PE3 or PE6) was used similarly to the sample A14. However, unlike the silane-grafted polyolefin PE12 used in the sample A14, the silane-grafted polyolefins PE13 and PE14 containing only one base polyolefin and used in the samples B1 and B2 do not have a high melting point and a low flexural modulus at the same time. Melting points of the silane-grafted polyolefins PE13 and PE14 are not higher than 80° C. Accordingly, in the samples B1 and B2, the crosslinked product had a low melting point and the insulated electric wire had low resistance to melting. Moreover, in the sample B2, the silane-grafted polyolefin PE14 have a high flexural modulus, and accordingly, the flexural modulus of the crosslinked product was not suppressed and flexibility of the insulated electric wire was low.

As shown by the above-described results, it is possible to obtain an insulated electric wire that has high resistance to melting, high flexibility, and excellent wear resistance by using a silane-crosslinkable resin composition that forms a crosslinked product having a melting point of 80° C. or higher and a flexural modulus of 100 MPa or less as in the samples A1 to A14. Also, by mixing a first polyolefin (a-1) and a second polyolefin (a-2) having mutually different melting points as base polyolefins that constitute the silane-grafted polyolefin (A) as in the samples A1 to A7, A10, and A11, it is possible to efficiently form such a crosslinked product having a high melting point and a low flexural modulus and obtain an insulated electric wire having high resistance to melting and high flexibility. It is more preferable to set the mass ratio (a-1)/(a-2) to fall within the range from 30/70 to 70/30 as in the samples A1 to A7. When the sample A1 is compared with the samples A12 and A13, it can be found that it is preferable to use an unmodified polyolefin (B) having a density of 0.950 g/cm³ or less and a flexural modulus of 200 MPa or less.

Although embodiments of the present disclosure have been described in detail, the present invention is by no means limited to the embodiments described above, and various modifications can be made within a range not departing from the gist of the present invention.

### LIST OF REFERENCE NUMERALS

1 Insulated electric wire
2 Conductor
3 Electric wire coating material

Listings of claims:

1. A flame-retardant resin composition comprising, as resin components:
a silane-grafted polyolefin (A) obtained by grafting a silane coupling agent onto at least one polyolefin;
an unmodified polyolefin (B); and
a modified polyolefin (C) having one or more functional groups selected from a carboxyl group, an ester group, an acid anhydride group, an amino group, and an epoxy group,
the flame-retardant resin composition further comprising:
a flame retardant (D); and
a crosslinking catalyst (E),
wherein a crosslinked product obtained by subjecting the flame-retardant resin composition to silane crosslinking has a melting point of 80° C. or higher and a flexural modulus of less than 80 MPa.

2. The flame-retardant resin composition according to claim 1,
wherein the at least one polyolefin constituting the silane-grafted polyolefin (A) includes:
a first polyolefin (a-1); and
a second polyolefin (a-2), and
the first polyolefin (a-1) has a higher melting point than the second polyolefin (a-2).

3. The flame-retardant resin composition according to claim 2,
wherein the first polyolefin (a-1) has a density of 0.870 g/cm³ or less, a melting point of 110° C. or higher, and a flexural modulus of 11 MPa or less,
the second polyolefin (a-2) has a density of 0.870 g/cm³ or less, a melting point of 60° C. or lower, and a flexural modulus of 11 MPa or less, and
the first polyolefin (a-1) and the second polyolefin (a-2) are mixed at a mass ratio (a-1)/(a-2) within a range of 30/70 or more and 70/30 or less.

4. A flame-retardant resin composition comprising, as resin components:
a silane-grafted polyolefin (A) obtained by grafting a silane coupling agent onto at least one polyolefin;
an unmodified polyolefin (B); and
a modified polyolefin (C) having one or more functional groups selected from a carboxyl group, an ester group, an acid anhydride group, an amino group, and an epoxy group,
the flame-retardant resin composition further comprising:
a flame retardant (D); and
a crosslinking catalyst (E),
wherein the at least one polyolefin constituting the silane-grafted polyolefin (A) includes:
a first polyolefin (a-1) having a density of 0.870 g/cm³ or less, a melting point of 110° C. or higher, and a flexural modulus of 11 MPa or less; and
a second polyolefin (a-2) having a density of 0.870 g/cm³ or less, a melting point of 60° C. or lower, and a flexural modulus of 11 MPa or less, and
the first polyolefin (a-1) and the second polyolefin (a-2) are mixed at a mass ratio (a-1)/(a-2) within a range of 30/70 or more and 70/30 or less.

5. The flame-retardant resin composition according to claim 1,
wherein the unmodified polyolefin (B) has a density of 0.950 g/cm³ or less and a flexural modulus of 200 MPa or less.

6. The flame-retardant resin composition according to claim 1, comprising, as the resin components:
10 parts by mass or more and 70 parts by mass or less of the silane-grafted polyolefin (A);
20 parts by mass or more and 60 parts by mass or less of the unmodified polyolefin (B); and
1 part by mass or more and 30 parts by mass or less of the modified polyolefin (C).

7. The flame-retardant resin composition according to claim 1, comprising at least one of magnesium hydroxide and aluminum hydroxide as the flame retardant (D) in a total amount of 30 parts by mass or more and 150 parts by mass or less with respect to 100 parts by mass of the resin components.

8. The flame-retardant resin composition according to claim 7,
wherein the magnesium hydroxide and the aluminum hydroxide have an average particle size of 0.5 μm or more and 5.0 μm or less.

9. The flame-retardant resin composition according to claim 1,
wherein the crosslinking catalyst (E) is contained in an amount of 0.1 parts by mass or more and 1 part by mass or less with respect to 100 parts by mass of the resin components.

10. The flame-retardant resin composition according to claim 1, further comprising at least one of:
a hindered phenol-based antioxidant (F);
a metal oxide (G);
a sulfur-based antioxidant (H); and
a lubricant (I).

11. The flame-retardant resin composition according to claim 10,
wherein the sulfur-based antioxidant (H) includes at least one imidazole-based compound.

12. The flame-retardant resin composition according to claim 10,
wherein the components (F) to (I) are contained in the following amounts with respect to 100 parts by mass of the resin components:
0.5 parts by mass or more and 20 parts by mass or less of the hindered phenol-based antioxidant (F);
0.5 parts by mass or more and 15 parts by mass or less of the metal oxide (G);
0.5 parts by mass or more and 20 parts by mass or less of the sulfur-based antioxidant (H); and
0.1 parts by mass or more and 5 parts by mass or less of the lubricant (I).

13. An insulated electric wire comprising:
a conductor; and
an electric wire coating material constituted by a crosslinked product of the flame-retardant resin composition according to claim 1 and covering an outer circumference of the conductor.

14. A wire harness comprising the insulated electric wire according to claim 13.
